(19) United States
(12) Patent Application Publication
(10) Pub. No.: US 2024/0211439 A1
(43) Pub. Date: Jun. 27, 2024

(54) AL/ML CONCIERGE FOR A MULTI-CLIENT DISTRIBUTED SYSTEM

(71) Applicant: HUBSPOT, INC., Cambridge, MA (US)

(72) Inventors: Dharmesh Pravinchandra SHAH, Belmont, MA (US); Dylan Christopher SELLBERG, Swampscott, MA (US)

(21) Appl. No.: 18/595,992

(22) Filed: Mar. 5, 2024

Related U.S. Application Data
(63) Continuation-in-part of application No. 18/428,305, filed on Jan. 31, 2024.
Application No. 18/428,305 is a continuation-in-part of application No. 18/196,672, filed on May 12, 2023.
(63) Continuation-in-part of application No. 17/654,544, filed on Mar. 11, 2022.
(63) Continuation-in-part of application No. 17/655,320, filed on Mar. 17, 2022.
Application No. 17/655,320 is a continuation of application No. 17/448,228, filed on Sep. 21, 2021.
(63) Continuation-in-part of application No. 18/196,672, filed on May 12, 2023.
(63) Continuation-in-part of application No. 18/217,594, filed on Jul. 2, 2023.
Application No. 18/217,594 is a continuation of application No. 17/882,950, filed on Aug. 8, 2022, now Pat. No. 11,727,287.
Application No. 17/882,950 is a continuation of application No. 16/716,688, filed on Dec. 17, 2019, now Pat. No. 11,449,775.
(63) Continuation-in-part of application No. 18/217,592, filed on Jul. 2, 2023.
Application No. 18/217,592 is a continuation of application No. 17/522,101, filed on Nov. 9, 2021, now Pat. No. 11,710,136.
Application No. 17/522,101 is a continuation of application No. 16/408,020, filed on May 9, 2019, now Pat. No. 11,200,581.
(63) Continuation-in-part of application No. 17/657,687, filed on Apr. 1, 2022.
Application No. 17/657,687 is a continuation of application No. 16/668,696, filed on Oct. 30, 2019, now Pat. No. 11,321,736.
Application No. 16/668,696 is a continuation of application No. PCT/US2018/032348, filed on May 11, 2018.
(63) Continuation-in-part of application No. 18/524,294, filed on Nov. 30, 2023.
Application No. 18/524,294 is a continuation of application No. 17/443,211, filed on Jul. 22, 2021, now Pat. No. 11,836,199.
Application No. 17/443,211 is a division of application No. 15/807,869, filed on Nov. 9, 2017.
(63) Continuation-in-part of application No. 18/114,657, filed on Feb. 27, 2023.
Application No. 18/114,657 is a continuation of application No. 17/121,300, filed on Dec. 14, 2020, now Pat. No. 11,604,842.
Application No. 17/121,300 is a division of application No. 14/854,591, filed on Sep. 15, 2015, now Pat. No. 10,867,003.
(63) Continuation-in-part of application No. 63/450,282, filed on Mar. 6, 2023.
(60) Provisional application No. 63/450,282, filed on Mar. 6, 2023.
(60) Provisional application No. 63/341,646, filed on May 13, 2022.
(60) Provisional application No. 63/160,446, filed on Mar. 12, 2021.
(60) Provisional application No. 63/080,900, filed on Sep. 21, 2020.
(60) Provisional application No. 62/785,544, filed on Dec. 27, 2018.
(60) Provisional application No. 62/669,617, filed on May 10, 2018.
(60) Provisional application No. 62/504,549, filed on May 11, 2017.
(60) Provisional application No. 62/419,772, filed on Nov. 9, 2016.
(60) Provisional application No. 62/050,548, filed on Sep. 15, 2014.

(51) Int. Cl. G06F 16/16; G06F 16/11; G06F 16/28

(52) U.S. Cl. CPC G06F 16/164; G06F 16/122; G06F 16/284

(57) ABSTRACT

Techniques are provided for implementing an artificial intelligence and machine learning (AI/ML) copilot (e.g., an AI/ML concierge). The AI/ML copilot receives a natural language command through a chat interface. The natural language command is parsed using AI/ML parsing functionality to determine a desired outcome. Programming code is generated for execution to achieve the desired outcome. The programming code is executed to generate content related to the desired outcome. The programming code interacts with objects within the CRM database in order to generate the content. In this way, the content is displayed through the chat interface.

### RELATED APPLICATIONS

This application claims priority to U.S. Provisional Patent Application, titled “AI/ML CONCIERGE FOR A MULTI-CLIENT DISTRIBUTED SYSTEM”, filed on Mar. 6, 2023 and accorded Application No. 63/450,282, which is incorporated herein by reference.

This application claims priority to and is a continuation-in-part of U.S. patent application, titled “MULTI-SERVICE BUSINESS PLATFORM SYSTEM HAVING CUSTOM WORKFLOW ACTIONS SYSTEMS AND METHODS”, filed on Jan. 31, 2024 and accorded application Ser. No. 18/428,305, which is incorporated herein by reference.

Application Ser. No. 18/428,305 is a continuation-in-part of U.S. patent application, titled “SYSTEM AND METHOD OF TRANSLATING A TRACKING MODULE TO A UNIQUE IDENTIFIER”, filed on May 12, 2023 and accorded application Ser. No. 18/196,672, which claims priority to U.S. Provisional Patent Application, filed on May 13, 2022 and accorded Application No. 63/341,646, which are incorporated herein by reference.

Application Ser. No. 18/428,305 is a continuation-in-part of U.S. patent application, titled “MULTI-SERVICE BUSINESS PLATFORM SYSTEM HAVING CUSTOM WORKFLOW ACTIONS SYSTEMS AND METHODS”, filed on Apr. 21, 2022 and accorded application Ser. No. 17/660,085, which claims priority to U.S. Provisional Patent Application, filed on Apr. 21, 2021 and accorded Application No. 63/201,274, which are incorporated herein by reference.

Application Ser. No. 18/428,305 is a continuation-in-part of U.S. patent application, titled “MULTI-SERVICE BUSINESS PLATFORM SYSTEM HAVING CONVERSATION INTELLIGENCE SYSTEMS AND METHODS”, filed on Mar. 11, 2022 and accorded application Ser. No. 17/654,544, which claims priority to U.S. Provisional Patent Application, filed on Mar. 12, 2021 and accorded Application No. 63/160,446, which are incorporated herein by reference.

Application Ser. No. 18/428,305 is a continuation-in-part of U.S. patent application, titled “MULTI-SERVICE BUSINESS PLATFORM SYSTEM HAVING CUSTOM OBJECT SYSTEMS AND METHODS”, filed on Mar. 17, 2022 and accorded application Ser. No. 17/655,320, which claims priority to and is a continuation of U.S. patent application, titled “MULTI-SERVICE BUSINESS PLATFORM SYSTEM HAVING CUSTOM OBJECT SYSTEMS AND METHODS”, filed on Sep. 21, 2021 and accorded application Ser. No. 17/448,228, which claims priority to U.S. Provisional Patent application, filed on Sep. 21, 2020 and accorded Application No. 63/080,900, which are incorporated herein by reference.

Application Ser. No. 18/428,305 is a continuation-in-part of U.S. patent application, titled “SYSTEM AND METHOD OF TRANSLATING A TRACKING MODULE TO A UNIQUE IDENTIFIER”, filed on May 12, 2023 and accorded application Ser. No. 18/196,672, which claims priority to U.S. Provisional Patent Application, filed on May 13, 2022 and accorded Application No. 63/341,646, which are incorporated herein by reference.

Application Ser. No. 18/428,305 is a continuation-in-part of U.S. patent application, titled “MULTI-CLIENT SERVICE SYSTEM PLATFORM”, filed on Jul. 2, 2023 and accorded application Ser. No. 18/217,594, which claims priority to and is a continuation of U.S. patent application, titled “MULTI-CLIENT SERVICE SYSTEM PLATFORM”, filed on Aug. 8, 2022 and accorded application Ser. No. 17/882,950, which claims priority to and is a continuation of U.S. patent application, titled “MULTI-CLIENT SERVICE SYSTEM PLATFORM”, filed on Dec. 17, 2019 and accorded application Ser. No. 16/716,688, which claims priority to U.S. Provisional Patent Application, filed on Dec. 27, 2018 and accorded Application No. 62/785,544, which are incorporated herein by reference.

Application Ser. No. 18/428,305 is a continuation-in-part of U.S. patent application, titled “MULTI-CLIENT SERVICE SYSTEM PLATFORM”, filed on Jul. 2, 2023 and accorded application Ser. No. 18/217,592, which claims priority to and is a continuation of U.S. patent application, titled “MULTI-CLIENT SERVICE SYSTEM PLATFORM”, filed on Nov. 9, 2021 and accorded application Ser. No. 17/522,101, which claims priority to and is a continuation of U.S. patent application, titled “MULTI-CLIENT SERVICE SYSTEM PLATFORM”, filed on May 9, 2019 and accorded application Ser. No. 16/408,020, which claims priority to U.S. Provisional Patent Application, filed on May 10, 2018 and accorded Application No. 62/669,617, which are incorporated herein by reference.

Application Ser. No. 18/428,305 is a continuation-in-part of U.S. patent application, titled “METHODS AND SYSTEMS FOR AUTOMATED GENERATION OF PERSONALIZED MESSAGES”, filed on Apr. 1, 2022 and accorded application Ser. No. 17/657,687, which claims priority to and is a continuation of U.S. patent application, titled “METHODS AND SYSTEMS FOR AUTOMATED GENERATION OF PERSONALIZED MESSAGES”, filed on Oct. 30, 2019 and accorded application Ser. No. 16/668,696, which claims priority to and is a continuation of International Patent Application, titled “METHODS AND SYSTEMS FOR AUTOMATED GENERATION OF PERSONALIZED MESSAGES”, filed on May 11, 2018 and accorded International Application Serial Number No. PCT/US18/32348, which claims priority to U.S. Provisional Patent Application, filed on May 11, 2017 and accorded Application No. 62/504,549, which are incorporated herein by reference.

Application Ser. No. 18/428,305 is a continuation-in-part of U.S. patent application, titled “METHODS AND SYSTEMS FOR A CONTENT DEVELOPMENT AND MANAGEMENT PLATFORM”, filed on Nov. 30, 2023 and accorded application Ser. No. 18/524,294, which claims priority to and is a continuation of U.S. patent application, titled “METHODS AND SYSTEMS FOR A CONTENT DEVELOPMENT AND MANAGEMENT PLATFORM”, filed on Jul. 22, 2021 and accorded application Ser. No. 17/443,211, which claims priority to and is a divisional application of U.S. patent application, titled “METHODS AND SYSTEMS FOR A CONTENT DEVELOPMENT AND MANAGEMENT PLATFORM”, filed on Nov. 9, 2017 and accorded application Ser. No. 15/807,869, which claims priority to U.S. Provisional Patent Application, filed on Nov. 9, 2016 and accorded Application No. 62/419,772, which are incorporated herein by reference.

Application Ser. No. 18/428,305 is a continuation-in-part of U.S. patent application, titled “METHOD OF ENHANCING CUSTOMER RELATIONSHIP MANAGEMENT CONTENT AND WORKFLOW”, filed on Feb. 27, 2023 and accorded application Ser. No. 18/114,657, which claims priority to and is a continuation of U.S. patent application, titled “METHOD OF ENHANCING CUSTOMER RELATIONSHIP MANAGEMENT CONTENT AND WORKFLOW”, filed on Dec. 14, 2020 and accorded application Ser. No. 17/121,300, which claims priority to and is a divisional application of U.S. patent application, titled “METHOD OF ENHANCING CUSTOMER RELATIONSHIP MANAGEMENT CONTENT AND WORKFLOW”, filed on Sep. 15, 2015 and accorded application Ser. No. 14/854,591, which claims priority to U.S. Provisional Patent Application, filed on Sep. 15, 2014 and accorded Application No. 62/050,548, which are incorporated herein by reference.

This application incorporates by reference in its entirety U.S. Pat. No. 11,449,775, entitled “MULTI-CLIENT SERVICE SYSTEM PLATFORM,” filed on Dec. 17, 2019; U.S. patent application Ser. No. 17/121,300, entitled “METHOD OF ENHANCING CUSTOMER RELATIONSHIP MANAGEMENT CONTENT AND WORKFLOW”, filed on Dec. 14, 2020; and U.S. patent application Ser. No. 17/660,086, entitled “MULTI-SERVICE BUSINESS PLATFORM SYSTEM HAVING CUSTOM WORKFLOW ACTIONS SYSTEMS AND METHODS,” filed on Apr. 21, 2022, which claims priority to U.S. Provisional Patent Application No. 63/201,274, filed on Apr. 21, 2021, which are incorporated herein by reference.

### BACKGROUND

Conventional systems for enabling marketing and sales activities for a client do not also respectively enable support and service interactions with customers, notwithstanding that the same individuals are typically involved in all of those activities for a business, transitioning in status from prospect, to customer, to client. While marketing activities, sales activities, and service activities strongly influence the success of each other, businesses are required to undertake complex and time-consuming tasks to obtain relevant information for one activity from the others. These tasks may include forming queries, using complicated APIs, or otherwise extracting data from separate databases, networks, or other information technology systems (some on premises and others in the cloud). The task may also include transforming data from one native format to another suitable form for use in a different environment, synchronizing different data sources when changes are made in different databases, normalizing data, cleansing data, and configuring it for use.

Many organizations store data within customer relationship management (CRM) systems. A client of the organization can access customer information that is stored as objects within a CRM system of a multi-client service system platform. The customer information may relate to customers of the organization, such as contact information, sales information, help desk tickets, and/or a variety of information related to the organization and/or customers of the organization. The CRM system can be used to store core objects natively provided by the CRM system and/or custom objects that are custom created and configured by the client.

CRM systems may generally provide the ability to manage and analyze interactions with customers for businesses. For example, these CRM systems may compile data from various communication channels (e.g., email, phone, chat, content materials, social media, etc.). Some CRM systems can be used to monitor and track CRM standard objects (core objects). These CRM standard objects can include typical business objects such as accounts (e.g., accounts of customers), contacts (e.g., persons associated with accounts), leads (e.g., prospective customers), and opportunities (e.g., sales or pending deals).

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a block diagram illustrating an embodiment of an artificial intelligence/machine learning (AI/ML) copilot in accordance with various embodiments of the present technology.

FIG. 1B is a block diagram illustrating an embodiment of an AI/ML copilot in accordance with various embodiments of the present technology.

FIG. 1C is a block diagram illustrating an embodiment of an AI/ML copilot in accordance with various embodiments of the present technology.

FIG. 2 is a flow chart illustrating an embodiment of a method for implementing an AI/ML copilot in accordance with various embodiments of the present technology.

FIG. 3 is an example of a computer readable medium in accordance with various embodiments of the present technology.

FIG. 4 is a block diagram illustrating an example of a computing device in accordance with various embodiments of the present technology.

FIG. 5 is a block diagram illustrating an example of an environment for hosting an AI/ML copilot in accordance with various embodiments of the present technology.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or computing devices for implementing an artificial intelligence/machine learning (AI/ML) copilot (e.g., an AI/ML concierge) are provided. The AI/ML copilot includes a chat interface, which allows users to input natural language commands that are processed using the power of AI/ML copilot. In this way, the AI/ML copilot is hosted as a conversational CRM chatbot. The AI/ML copilot can generate a wide variety of outputs based upon the natural language commands, such as programmatically generating reports, a blog on a particular topic, a presentation slide, a spreadsheet, images, software code, emails, contacts, etc. With AI/ML copilot, a user can complete a task using a declarative approach where the user inputs a natural language statement as a command/query that describes an outcome (e.g., “create a helpdesk service ticket about my dropped phone calls”), but does not include the actual functional steps or code to achieve the outcome. Instead, the AI/ML copilot takes the natural language statement as input, and generates and performs the functional steps or code that produces the outcome described by the natural language statement.

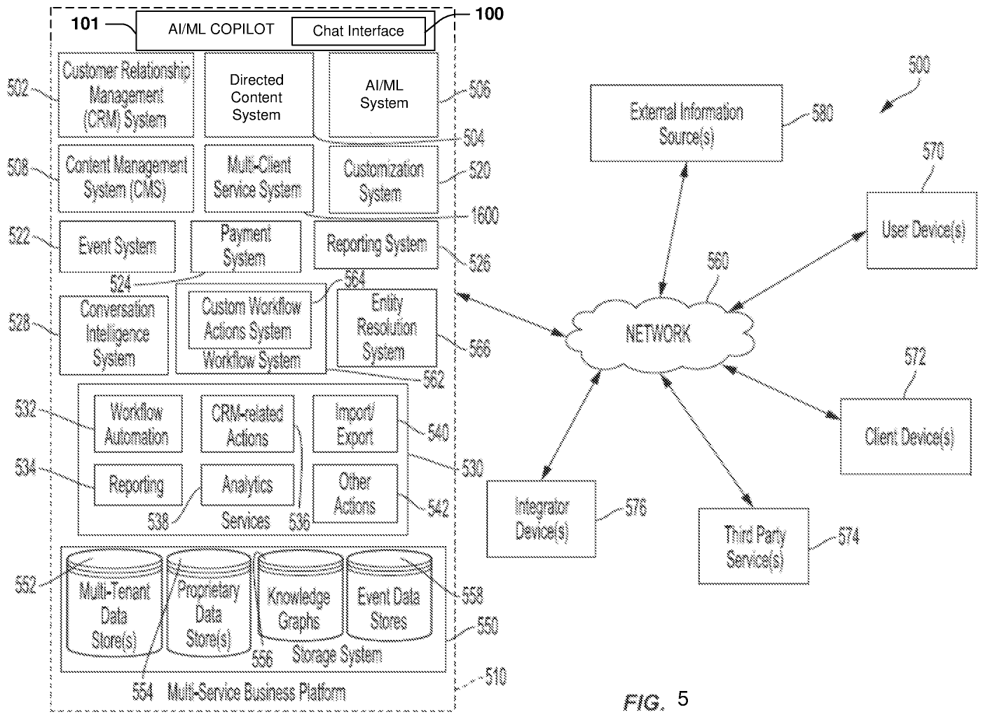

The AI/ML copilot utilizes the power of generative AI and a CRM database to create an all-in-one AI powered tool that can accomplish any task related to a multi-client service system platform such a multi-service business platform 510 of FIG. 5. A user can ask the AI/ML copilot to perform tasks by inputting natural language statements/commands through the chat interface. With this integration of generative AI and data from the CRM database, the AI/ML copilot can perform tasks such as adding contacts into the CRM database (e.g., the AI/ML copilot will identify and populate relevant properties within contacts objects in the CRM database to reduce manual data entry that can be error prone), generating custom reports (e.g., reports related to marketing, sales, and customer service), drafting personalized emails that are tailored to a recipient (e.g., draft a follow-up email for a prospect, draft a thank you note, creating a marketing email using campaign information in the CRM database, etc.), creating original IA images for blog articles, scheduling a task to be performed, and a wide variety of other tasks related to the modules/systems of the multi-client service system platform. In this way, the user no longer needs to interface with a CRM application in order to view and interact with data and perform tasks. This significantly streamlines the user's interaction with the multi-client service system platform by providing a single chat interface through which the user can utilize natural language statements that invoke the generative AI to perform tasks related to the multi-client service system platform on behalf of the user (e.g., new contacts, emails, reports, spreadsheets, presentations, and/or other content can be created on the fly without manual data entry that can otherwise be error prone and cause erroneous data to be stored within the CRM database).

In some embodiments, the AI/ML copilot is linked to other various modules a multi-client service system platform such as data sources (e.g., a website, a customer relationship management database, an image repository, etc.), applications (e.g., a spreadsheet application, a presentation application, a word processing application, a social network application, a messaging application, etc.), and services (e.g., an email service) in order to enhance the capabilities of the chat interface. In some embodiments, the AI/ML copilot links to a customer relationship management (CRM) system in order to leverage information within the CRM system and to populate new information within the CRM system (e.g., create tasks, create contacts, view marketing information, perform various analysis on sales data, create reports, etc.) based upon natural language commands input through the chat interface. In some embodiments, the AI/ML copilot and/or the chat interface may be integrated into and/or is a part of the multi-client service system platform.

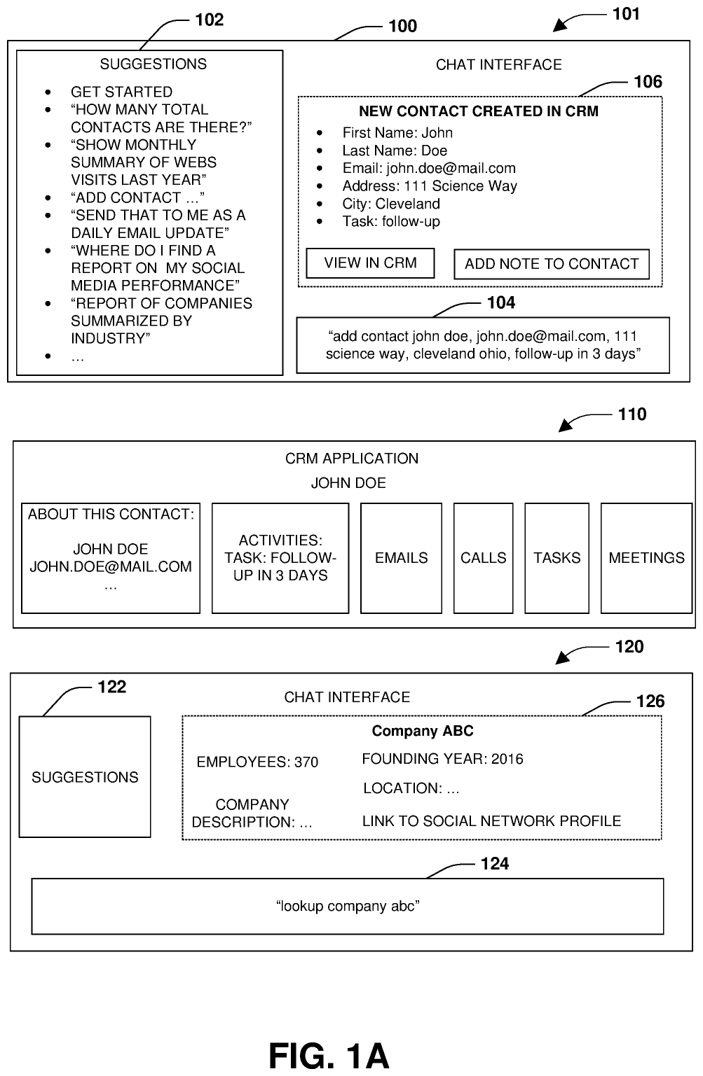

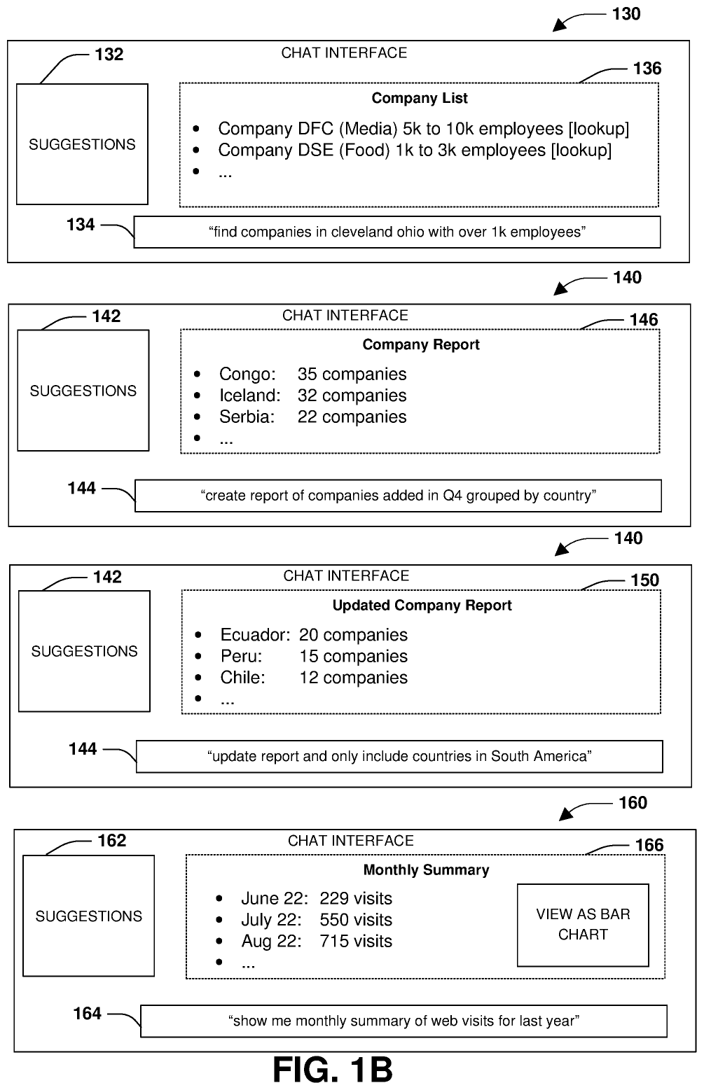

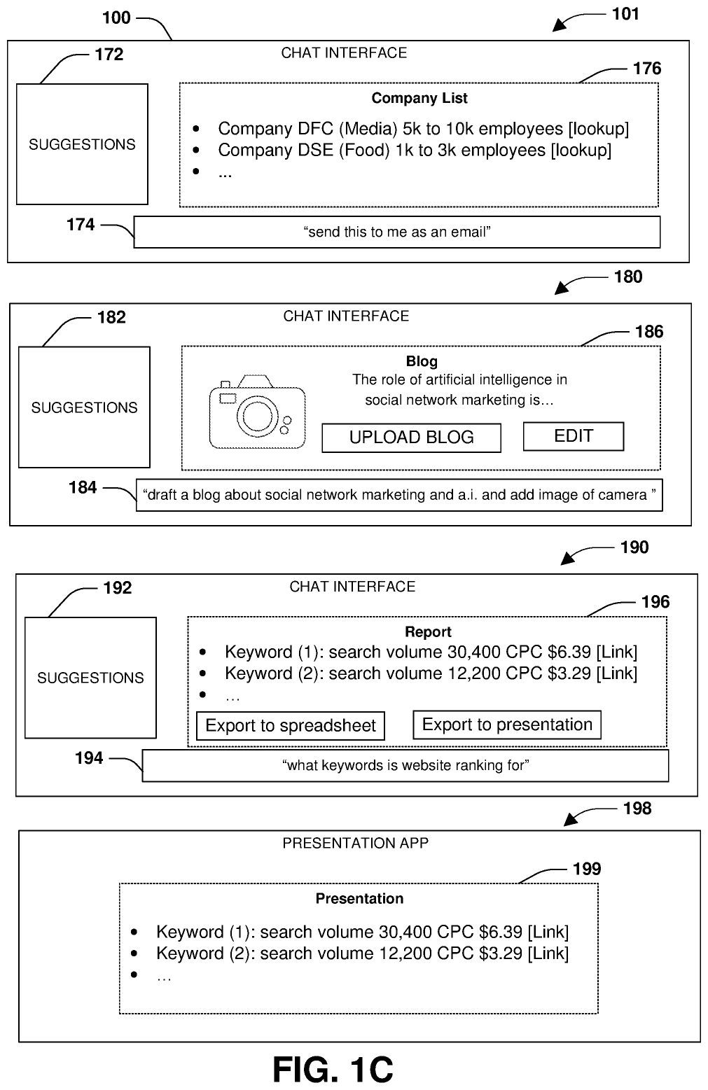

The AI/ML copilot may implement various application programming interfaces (APIs) in order to interface with the modules/systems of the multi-client service system platform (e.g., an API used to access the CRM system, a REST API to access a service accessible over a network, etc.). The AI/ML copilot may link to various applications, services, and content such as a spreadsheet application, a word processing application, a presentation application, a blogging service, a social network service, websites, databases, an image repository, social network profiles and posts, and/or other content in order to process natural language commands input through the chat interface, which is described in different use cases in FIGS. 1A-1C.

In an embodiment, the AI/ML copilot links to an artificial intelligence system of an integrator app that can create images and art from descriptions submitted through the chat interface in natural language. In another embodiment, the AI/ML copilot links to another integrator app such as a keyword research service or tool that provides topics and content (e.g., ideas, concepts, topics, paragraphs of text, sentences of text, etc.) related to natural language commands input through a chat interface of the AI/ML copilot.

When a user inputs a natural language command through the chat interface (e.g., “create a helpdesk service ticket about my dropped phone calls;” “creating a report about company ABC;” etc.), the AI/ML copilot automatically selects certain modules, corresponding to the platforms, data sources, applications, and/or services, to utilize for processing the natural language command (e.g., selecting a certain order of modules and systems of the multi-service business platform 510 to invoke). The natural language command may describe a desired outcome such as the report about the company ABC, which may be used by the AI/ML copilot to select one or more of the modules to utilize for generating the desired outcome. The desired outcome, derived from the natural language command, may be used to select an order with which to access/invoke the modules, what inputs to input into each module (e.g., an output from one module may be used as an input to another module), and what outputs are expected from each module. For example, a CRM system and storage system, a website of the company ABC, a business information repository, a social network service hosting a social network profile of the company ABC, and/or other modules or content may be selected in order to obtain information that the AI/ML copilot will use to generate the report. In this way, natural language commands input through the chat interface are used by the AI/ML copilot to select, order, and/or invoke certain modules (systems) in order to generate content using artificial intelligence, machine learning, and/or various types of models, which can be used by business growth professionals such as customer service agents, executives, a marketing team, a sales team, and/or a wide variety of other types of users.

FIG. 1A illustrates an embodiment of the chat interface 100 powered by the AI/ML copilot 101 (e.g., an AI/ML concierge) of the platform 510. The chat interface 100 may be populated with a natural language input interface 104 through which a user can input natural language commands to the AI/ML copilot 101. The chat interface 100 may include a suggestions interface 102. The AI/ML copilot 101 may generate suggested natural language commands to populate within the suggestions interface 102 based upon a role of the user (e.g., the user may be part of a marketing, sales, IT, or management team of a company), a location of the user, prior natural language commands submitted by the user (e.g., the user may have recently submitted natural language commands to add new contacts from a contact spreadsheet into a storage system 550), an employer of the user, information within emails of the user (e.g., a work email may indicate that the user is to add certain people as new contacts into the storage system 550), information within a social network profile of the user, a web browser search history of the user, a purchase history of the user, information accessible through a module (e.g., information accessible through a CRM System 502, information within the spreadsheet accessible through a spreadsheet application or online spreadsheet hosting service, etc.), etc.

The suggestions interface 102 may be populated with the suggested natural language commands that a user can select for inserting into the natural language input interface 104, such as “how many total contacts are there?”, “show monthly summary of web visits last year”, “add contact . . . ”, “send that to me as a daily email update”, “where do I find a report on my social media performance”, “report of companies summarized by industry”, etc. In response to the user selecting a suggested natural language command through the suggestions interface 102, the suggested natural language command may be auto populated within the natural language input interface 104. In some embodiments, the suggested natural language command may be auto submitted through the natural language input interface 104 or merely populated within the natural language input interface 104 for further user editing.

In some embodiments, the user may input a first natural language command “add contact john doe, john.doe@mail.com, 111 science way, cleveland ohio, follow-up in 3 days” into the natural language input interface 104. In response to the user submitting the first natural language command through the natural language input interface 104, the AI/ML copilot 101 may parse the first natural language command using various parsing functionality (e.g., a declarative programming model or other functionality used to identify desired outcomes described in natural language, entity recognition functionality, semantic parsing, topic identification functionality, text classification functionality, deep learning-based text understanding, natural language processing functionality, machine learning, etc.). The AI/ML copilot 101 evaluates the first natural language command using artificial intelligence, declarative programming models, and/or other machine learning in order to determine what functions and/or programming code to perform and what modules/systems (e.g., systems of the multi-service business platform 510) to use in order to achieve/generate the desired outcome. In some embodiments, the AI/ML copilot 101 may identify a desired outcome of creating a contact for John Doe, along with a task of following up in 3 days with John Doe.

The AI/ML copilot 101 may identify a module (system) corresponding to the CRM system 502 that could be used as part of completing the desired outcome. The AI/ML copilot 101 may generate an output 106 by generating a contact in a particular format that could be used to create and store a contact within the CRM System 502. The AI/ML copilot 101 may capitalize certain words, fill in missing information (e.g., add a zip code), query external data sources or modules in order to identify additional/supplementary information to include within the contact (e.g., retrieve a photo of John Doe from a social network profile), and/or perform other processing upon the first natural language command in order to create the contact. The AI/ML copilot 101 may display the output 106 of the contact through the chat interface 100. The AI/ML copilot 101 may populate the output 106 with a View in CRM interface element and an Add Note to Contact interface element. The user may utilize the Add Note to Contact interface element in order to add notes and/or edit the contact generated by the AI/ML copilot 101. The user may utilize the View in CRM interface element in order to invoke the AI/ML copilot 101 to utilize various APIs in order to add the contact into the CRM System 502. Additionally, the user may be transitioned to a CRM application 110 that displays the contact added to the CRM System 502. The CRM application 110 may allow the user to view the contact, emails received by the contact, calls made to the contact, tasks related to the contact, meetings scheduled with the contact, activities related to the contact such as the task created by the AI/ML copilot 101 for a later date or time period to follow-up with the contact, etc.

FIG. 1A also illustrates a chat interface 120 powered by AI/ML copilot 101. The chat interface 120 may be populated with a natural language input interface 124 and a suggestions interface 122. The user may input a second natural language query “lookup company ABC” into the natural language input interface 124. The AI/ML copilot 101 may parse the second natural language query using various parsing functionality in order to identify a desired outcome of creating a company overview for Company ABC. The AI/ML copilot 101 may utilize the desired outcome and/or information parsed from the second natural language query in order to determine what functions and/or programming code to implement, which modules (systems) to utilize, what inputs to input into the modules, an order with which to utilize the modules, whether outputs from certain modules should be used as inputs for other modules, and/or how to format and/or combine the outputs for generating the desired outcome. In this way, the AI/ML copilot 101 creates an output 126 of the company overview for Company ABC for display through the chat interface 120. The output 126 may be populated with information retrieved from various modules (e.g., a website of Company ABC, a social network service hosting a social network profile of Company ABC, information about Company ABC within the Storage System 550, SEC filing data for Company ABC, news articles related to Company ABC, etc.). The output 126 may be populated with a number of employees, a company description, a founding year, a location, a link to a social network profile of Company ABC, and/or other information related to Company ABC.

FIG. 1B illustrates a chat interface 130 powered by the AI/ML copilot 101. The chat interface 130 may be populated with a natural language input interface 134 and a suggestions interface 132. The user may input a third natural language query “find companies in cleveland ohio with over 1 k employees” into the natural language input interface 134. The AI/ML copilot 101 may parse the third natural language query using various parsing functionality in order to identify a desired outcome of generating a list of companies located in Cleveland, Ohio that have over 1,000 employees. The AI/ML copilot 101 may utilize the desired outcome and/or information parsed from the third natural language query in order to determine what functions and/or programming code to implement, which modules to utilize, what inputs to input into the modules, an order with which to utilize the modules, whether outputs from certain modules should be used as inputs for other modules, and/or how to format and/or combine the outputs for generating the desired outcome. In this way, the AI/ML copilot 101 creates an output 136 of the list of companies for display through the chat interface 130. The output 136 may be populated with information retrieved from various modules, such as information from the storage system 550 relating to companies located in Cleveland, Ohio with over 1,000 employees. The output 136 may also be populated with lookup links to perform web searches for additional information associated with each company (e.g., a hyperlink to search results for a company's name).

FIG. 1B also illustrates a chat interface 140 powered by AI/ML copilot 101. The chat interface 140 may be populated with a natural language input interface 144 and a suggestions interface 142. The user may input a fourth natural language query “create report of companies added in Q4 grouped by country” into the natural language input interface 144. The AI/ML copilot 101 may parse the fourth natural language query using various parsing functionality in order to identify a desired outcome of generating a company report that lists the number of companies added as clients in the 4th quarter of a current year where the list is grouped by different countries. The AI/ML copilot 101 may utilize the desired outcome and/or information parsed from the fourth natural language query in order to determine what functions and/or programming code to implement, which modules to utilize, what inputs to input into the modules, an order with which to utilize the modules, whether outputs from certain modules should be used as inputs for other modules, and/or how to format and/or combine the outputs for generating the desired outcome. In this way, the AI/ML copilot 101 creates an output 146 of the company report for display through the chat interface 140. The output 146 may be populated with information retrieved from various modules, such as information from the storage system 550 relating to companies that were added as clients in the 4th quarter of a current year. The AI/ML copilot 101 may reformat and/or group the information from the storage system 550 based upon countries for inclusion within the company report.

The user may subsequently submit a fifth natural language query of “update report and only include countries in South America” through the natural language input interface 144 while the company report is displayed as the output 146 through the chat interface 140. Accordingly, the AI/ML copilot 101 may parse the fifth natural language query using various parsing functionality in order to identify a desired outcome of updating the company report by filtering out countries that are not included within South America. The AI/ML copilot 101 may utilize the desired outcome and/or information parsed from the fifth natural language query in order to determine what functions/codes to implement, which modules to utilizes, what inputs to input into the modules, an order to which to utilizes the modules, whether outputs from certain modules should be used as inputs for other modules, and/or how to format and/or combine the outputs for generating the desired outcome. In this way, the AI/ML copilot 101 creates an updated output 150 of an updated company report for display through the chat interface 140.

FIG. 1B also illustrates a chat interface 160 powered by the AI/ML copilot 101. The chat interface 160 may be populated with a natural language input interface 164 and a suggestions interface 162. The user may input a sixth natural language query “show me monthly summary of web visits for last year” into the natural language input interface 164. The AI/ML copilot 101 may parse the sixth natural language query using various parsing functionality in order to identify a desired outcome of generating a monthly summary of users visiting a website of the user during the prior year (2022). The AI/ML copilot 101 may utilize the desired outcome and/or information parsed from the sixth natural language query in order to determine what functions and/or programming code to implement, which modules to utilize, what inputs to input into the modules, an order with which to utilize the modules, whether outputs from certain modules should be used as inputs for other modules, and/or how to format and/or combine the outputs for generating the desired outcome. In this way, the AI/ML copilot 101 creates an output 166 of the monthly summary for display through the chat interface 160. The output 166 may be populated with information retrieved from various modules, such as information from the storage system 550 relating to users visiting the user's website.

FIG. 1C illustrates a chat interface 170 powered by AI/ML copilot 101. The chat interface 170 may be populated with a natural language input interface 174 and a suggestions interface 172. The user may input a seventh natural language query “send this to me as an email” into the natural language input interface 174 while an output 176 of a company list is displayed through the chat interface 170. The AI/ML copilot 101 may parse the seventh natural language query using various parsing functionality in order to identify a desired outcome of the chat interface 170 constructing and sending an email to an email address of the user where the email includes the company list as either an attachment or within a body of the email. The AI/ML copilot 101 may utilize the desired outcome and/or information parsed from the seventh natural language query in order to determine what functions and/or programming code to implement, which modules to utilize (e.g., an email service), what inputs to input into the modules, an order with which to utilize the modules, whether outputs from certain modules should be used as inputs for other modules, and/or how to format and/or combine the outputs for generating the desired outcome. In this way, the AI/ML copilot 101 generates the email and transmits the email through an email service to a recipient.

FIG. 1C also illustrates a chat interface 180 powered by AI/ML copilot 101. The chat interface 180 may be populated with a natural language input interface 184 and a suggestions interface 182. The user may input an eighth natural language query “draft a blog about social network marketing and a.i. and add image of camera” into the natural language input interface 184. The AI/ML copilot 101 may parse the eighth natural language query using various parsing functionality in order to identify a desired outcome of creating a blog describing how artificial intelligence is used in social network marketing, which includes an image of a camera.

The AI/ML copilot 101 may utilize the desired outcome and/or information parsed from the eighth natural language query in order to determine what functions and/or programming code to implement, which modules to utilize (e.g., a keyword research service, a text generation service, an image generation service, etc.), what inputs to input into the modules, an order with which to utilize the modules, whether outputs from certain modules should be used as inputs for other modules, and/or how to format and/or combine the outputs for generating the desired outcome. In this way, the AI/ML copilot 101 creates an output 186 of the blog with text describing how artificial intelligence is used in social network marketing and with the image of a camera. The blog may have a certain length, reading level, and/or format (e.g., bullet points, outline, etc.) derived from the desired outcome. The output 186 may be populated with an Upload Blog interface element that the user can click in order to upload/post the blog to a website, blogging service, etc. The output 186 may be populated with an Edit interface element that the user can click in order to transition into a blog editor interface for modifying the text and/or the image of the camera.

FIG. 1C also illustrates a chat interface 190 powered by AI/ML copilot 101. The chat interface 190 may be populated with a natural language input interface 194 and a suggestions interface 192. The user may input a ninth natural language query “what keywords is website ranking for” into the natural language input interface 194. The AI/ML copilot 101 may parse the ninth natural language query using various parsing functionality in order to identify a desired outcome of creating a report that lists information about keywords associated with a website of the user. The AI/ML copilot 101 may utilize the desired outcome and/or information parsed from the ninth natural language query in order to determine what functions and/or programming code to implement, which modules to utilize, what inputs to input into the modules, an order with which to utilize the modules, whether outputs from certain modules should be used as inputs for other modules, and/or how to format and/or combine the outputs for generating the desired outcome. In this way, the AI/ML copilot 101 creates an output 196 of a report about the keywords associated with the website, which may include the keywords, a search volume for the keywords, a cost per click for the keywords, and/or links to landing pages for the keywords. The output 196 may be populated with an Export to Spreadsheet interface element that the user can click in order to export the report into a spreadsheet hosted by a spreadsheet service. The output 196 may be populated with an Export to Presentation interface element that the user can click in order to export the report into a presentation 199 hosted by a presentation application 198.

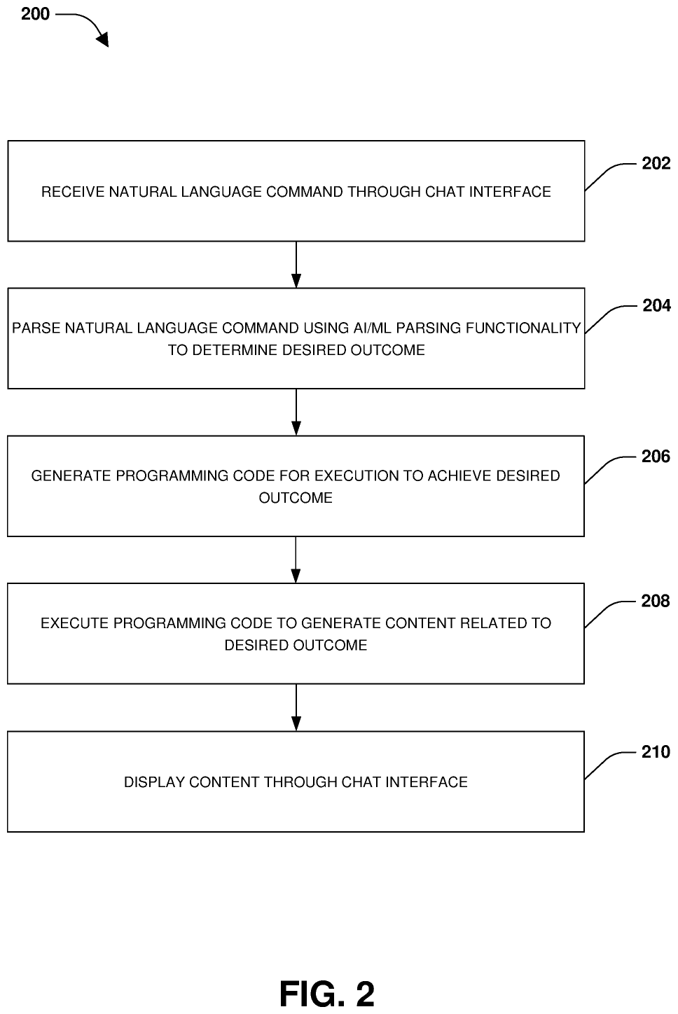

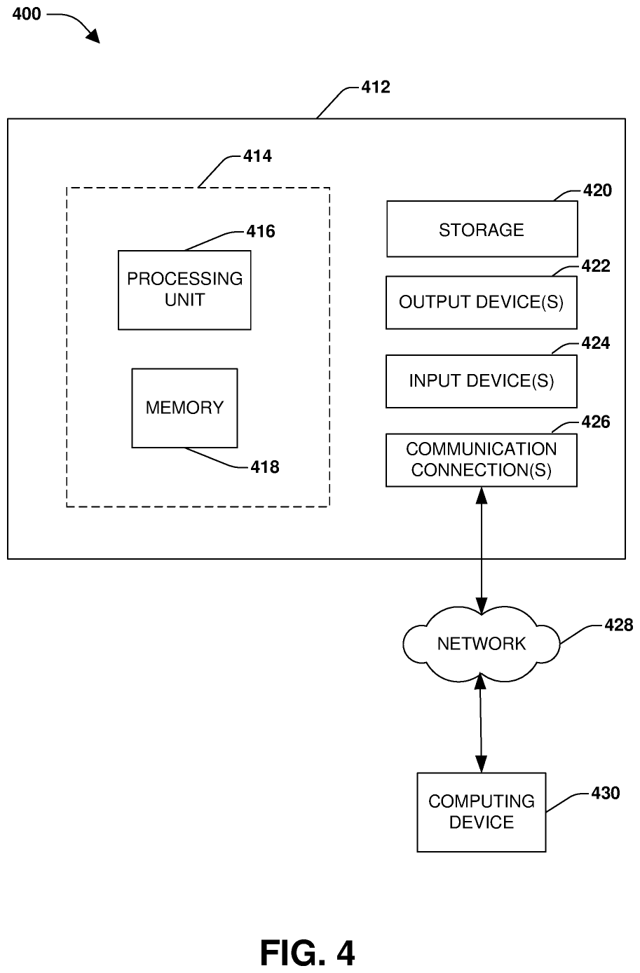

FIG. 2 is a flow chart illustrating an embodiment of a method 200 for implementing an AI/ML copilot 101 (e.g., an AI/ML concierge). In some embodiments, the method 200 is implemented by a system (e.g., a computing system, a server, a virtual machine, a container of a Kubernetes environment, the environment 500 of FIG. 5, the computing device 412 of FIG. 4, etc.). The system may comprise a storage system that includes a customer relationship management (CRM) database. In some embodiments, the CRM database may be hosted by the multi-service business platform 510 of FIG. 5. The CRM database may store contacts, service tickets (e.g., customer service tickets created for tracking customer service calls, chats, issues, and resolutions), company information, contracts, business opportunities, and/or a wide variety of data as objects such as core objects natively supported by the CRM database and custom objects defined by users because the custom objects are not natively defined by the CRM database. The system may comprise a multi-client service system (e.g., the multi-service business platform 510 or any other portion/component/system/etc. of environment 500). The multi-client service system includes the AI/ML copilot 101 configured to host the chat interface 100.

In some embodiments, the AI/ML copilot 101 includes a suggestion interface 202 populated with suggested natural language commands. In some embodiments, the suggested natural language commands may be determined based upon commands supported by the CRM database (e.g., an add contact command, a create custom object command, a delete object command, a command to edit fields or values within an object, etc.). In some embodiments, the suggested natural language commands may be determined based upon commands supported by applications accessible to the AI/ML copilot 101 such as a create spreadsheet command, an open presentation command, a create social network post, an edit blog post, a generate AI image and add to an existing blog, a generate and display report command, etc. In some embodiments, the suggested natural language commands may be determined based upon prior conversations between a user and the AI/ML copilot 101 (e.g., the user may have previously asked about reviews for bikes, and thus a suggested natural language command may relate to purchasing a bike, a command to generate a social network post asking for bike recommendations, etc.). In some embodiments, the suggested natural language commands may be determined based upon other information such as demographics of the user, a role of the user (e.g., the user may be in charge of purchasing coffee beans for a grocery store, and thus a command may relate to generate a report regarding coffee prices, purchase history, current inventory, etc.).

In some embodiments, the AI/ML copilot 101 may be populated with a toggle option. The toggle option may transition the AI/ML copilot 101 between a manual creation mode and an AI generated content mode. While in the manual creation mode, a user can input content through the chat interface 101 and/or other input interfaces (e.g., an upload image interface for uploading an image, an upload document interface for uploading a file or document, or other content creation/upload interfaces for inputting content through the AI/ML copilot 101). The AI/ML copilot 101 may utilize the content to perform various tasks such as creating and populating information into an object within the CRM database, a spreadsheet, a presentation, a blog, a social network post, an email, etc. While in the AI generated content mode, the AI/ML copilot 101 may generate text, images, audio, objects within the CRM database, presentation slides, spreadsheet entries, blogs, social network posts, emails, and/or other content based upon input received through the chat interface.

During operation 202 of method 200, a natural language command may be received through the chat interface 101 of the AI/ML copilot 101. For example, the user may input “how many customers have been invoiced within the past 6 months” into the chat interface 101. During operation 204 of method 200, the AI/ML copilot 101 utilizes various AI models to parse the natural language command to determine a desired outcome (e.g., a generative pre-trained transformer model, a bidirectional encoder representations for transformers model, a pathways language model, an OpenAI model, or any other type of model that can interpret text input). For example, the AI/ML copilot 101 may utilize one or more AI models to determine a desired outcome that a report is to be generated from data stored within customer objects and invoicing objects within the CRM database, and the report is to include a count of customers that were invoiced over the past 6 months, where the report could be generated as a single number, a list of the customers, or some other format of information.

During operation 206 of method 200, programming code is generated for execution to achieve the desired outcome. The programming code may include database commands (e.g., SQL commands) that can be executed against the CRM database to extract information from the customer objects and invoicing objects. The programming code may include code to create a report such as a count and list of the customers that were invoiced over the past 6 months. The programming code may include code to open a spreadsheet application, create a new spreadsheet, populate the spreadsheet with the report, save a copy of the spreadsheet, and display the spreadsheet application with the spreadsheet to the user.

Other programming code may be generated for other natural language commands and desired outcomes, such as programming code to generate an image and text, access a blogging site, create a blog, include the generated image and text within the blog, and publish the blog. In some embodiments, programming code is created to generate an image and/or text, access an email service, create an email, include the generated image and/or text within the email (e.g., attach the generated image to the email and/or populate a subject and body of the email with the text), and send the email. In some embodiments, programming code is created to generate an image and/or text, access a social network service, create a post, include the generated image and/or text within the post, and publish the post. In some embodiments, programming code is created to generate an image and/or text, access a presentation application, create a presentation, include the generated image and/or text within the presentation, and save the presentation. In some embodiments, programming code is created to generate database commands for performing operations directed to the CRM database, such as creating objects, modifying objects, reading data from objects, deduplicating objects (e.g., identify similar or the same objects (redundant objects) and retaining merely one of the objects), etc.

During operation 208 of method 200, the programming code is executed to generate content related to the desired outcome. In some embodiments, the programming code is executed to interact with objects within the CRM database. For example, the programming code may create a new object, delete an object, read information from an object, write to an object, modify an object, deduplicate an object with respect to other similar/redundant objects, etc. During operation 210 of method 200, the content is displayed through the chat interface 100. In some embodiments, the natural language command, the programming code, and/or the content may relate to an external application, service, or website. Accordingly, the AI/ML copilot 101 may transition the user from the chat interface to an external application, service, or website. In some embodiments, the AI/ML copilot 101 may transition the user to a CRM application populated with data stored within the CRM database (e.g., a view of objects created by the AI/ML copilot 101). In some embodiments, the AI/ML copilot 101 may transition the user to a spreadsheet application displaying a spreadsheet generated and populated by the AI/ML copilot 101 using information within the content displayed through the chat interface 100 and/or other content generated/retrieved based upon the natural language command. In some embodiments, the AI/ML copilot 101 may transition the user to a presentation application displaying a presentation generated and populated by the AI/ML copilot 101 using information within the content displayed through the chat interface 100 and/or other content generated/retrieved based upon the natural language command. In some embodiments, the AI/ML copilot 101 may transition the user to a blogging service displaying a blog generated by the AI/ML copilot 101 using information within the content displayed through the chat interface 100 and/or other content generated/retrieved based upon the natural language command.

In some embodiments, the AI/ML copilot 101 may transition the user to a social media service displaying a social media post generated by the AI/ML copilot 101 using information within the content displayed through the chat interface 100 and/or other content generated/retrieved based upon the natural language command.

In some embodiments, the AI/ML copilot 101 may transition the user to a forum displaying a forum post generated by the AI/ML copilot 101 using information within the content displayed through the chat interface 100 and/or other content generated/retrieved based upon the natural language command.

In some embodiments, the AI/ML copilot 101 may transition the user to an email application or service displaying an email generated by the AI/ML copilot 101 using information within the content displayed through the chat interface 100 and/or other content generated/retrieved based upon the natural language command.

In some embodiments, the AI/ML copilot 101 executes a database command to modify the CRM database based upon receiving a chat-based command through the chat interface 100. In some embodiments, the AI/ML copilot 101 creates a new contact object within the CRM database based upon receiving a chat-based command through the chat interface 100. In some embodiments, the AI/ML copilot 101 creates and sends an email based upon receiving a chat-based command through the chat interface 100. In some embodiments, the AI/ML copilot 101 obtains/generates and displays a report generated from objects within the CRM database based upon receiving a chat-based command through the chat interface 100. In some embodiments, the AI/ML copilot 101 deduplicates objects within the CRM database based upon receiving a chat-based command through the chat interface 100. In some embodiments, the AI/ML copilot 101 automatically captures and transcribes a recorded conversation to create a transcript for the user based upon receiving a chat-based command through the chat interface 100 (e.g., a text based transcription may be generated from an audio or video recording). In some embodiments, the AI/ML copilot 101 logs and segments email contact information based upon receiving a chat-based command through the chat interface 100 (e.g., segmenting similar contacts, represented by objects within the CRM database, into groups based upon demographics or other information indicative of whether two contacts are similar or dissimilar—age, gender, job title, company, purchase history, potential customer, etc.).

In some embodiments, the AI/ML copilot 101 imports contact and company information from a spreadsheet by mapping each cell of the spreadsheet to CRM properties of objects within the CRM database based upon receiving a chat-based command through the chat interface 100 (e.g., a cell of the spreadsheet may store a phone number that may be imported into a phone number field of a contact object or vice versa; a contact object may include an address field storing an address that may be imported into a cell of the spreadsheet; etc.). In some embodiments, the AI/ML copilot 101 generates a follow-up email based upon information within the objects in the CRM database based upon receiving a chat-based command through the chat interface 100 (e.g., an object may describe a contract being negotiated by the user with a client, and thus contract information from the object may be used to generate a follow-up email to the client). In some embodiments, the AI/ML copilot 101 generates and includes an image within a blog article based upon receiving a chat-based command through the chat interface 100. In some embodiments, the AI/ML copilot 101 generates a customer report using information from the objects within the CRM database based upon receiving a chat-based command through the chat interface 100.

In some embodiments, a system is provided. The system includes a storage system including a customer relationship management (CRM) database; and a multi-client service system platform that includes an artificial intelligence and machine learning (AI/ML) copilot (e.g., an AI/ML concierge) configured to host a chat interface, wherein the AI/ML copilot performs operations including: receiving a natural language command through the chat interface; parsing the natural language command using AI/ML parsing functionality to determine a desired outcome; generating programming code for execution to achieve the desired outcome; executing the programming code to generate content related to the desired outcome, wherein the programming code interacts with objects within the CRM database; and displaying the content through the chat interface.

In some embodiments, the AI/ML copilot displays a suggestion interface populated with suggested natural language commands.

In some embodiments, the AI/ML copilot transitions a user from the chat interface to a CRM application.

In some embodiments, the AI/ML copilot transitions a user from the chat interface to a spreadsheet application displaying a spreadsheet generated and populated by the AI/ML copilot using information within the content displayed through the chat interface.

In some embodiments, the AI/ML copilot transitions a user from the chat interface to a presentation application displaying a presentation generated and populated by the AI/ML copilot using information within the content displayed through the chat interface.

In some embodiments, the AI/ML copilot transitions a user from the chat interface to a blog service displaying a blog generated by the AI/ML copilot using information within the content displayed through the chat interface.

In some embodiments, a method is provided. The method includes receiving a natural language command through a chat interface hosted by an artificial intelligence and machine learning (AI/ML) copilot (e.g., an AI/ML concierge) of a multi-client service system platform; parsing the natural language command using AI/ML parsing functionality to determine a desired outcome; generating programming code for execution to achieve the desired outcome; executing the programming code to generate content related to the desired outcome, wherein the programming code interacts with objects within a customer relationship management (CRM) database of a storage system; and displaying the content through the chat interface.

In some embodiments, the method includes providing, through the chat interface, a toggle option to toggle between manual creation and AI generated content by the AI/ML copilot for creating new content.

In some embodiments, the method includes in response to the AI/ML copilot receiving a chat-based command through the chat interface, executing a database command to modify the CRM database.

In some embodiments, the method includes in response to the AI/ML copilot receiving a chat-based command through the chat interface, creating a new contact object within the CRM database.

In some embodiments, the method includes in response to the AI/ML copilot receiving a chat-based command through the chat interface, creating and sending an email.

In some embodiments, the method includes in response to the AI/ML copilot receiving a chat-based command through the chat interface, obtaining and displaying a report generated from the objects within the CRM database.

In some embodiments, the method includes in response to the AI/ML copilot receiving a chat-based command through the chat interface, deduplicating the objects within the CRM database.

In some embodiments, the method includes in response to the AI/ML copilot receiving a chat-based command through the chat interface, automatically capturing and transcribing a recorded conversation to create a transcription.

In some embodiments, the method includes in response to the AI/ML copilot receiving a chat-based command through the chat interface, logging and segmenting email contact information.

In some embodiments, the method includes in response to the AI/ML copilot receiving a chat-based command through the chat interface, importing contact and company information from a spreadsheet by mapping each cell of the spreadsheet to a CRM property of the objects within the CRM database.

In some embodiments, a non-transitory machine readable medium is provided. The non-transitory machine readable medium stores instructions that when executed facilitate performance of operations including receiving a natural language command through a chat interface hosted by an artificial intelligence and machine learning (AI/ML) copilot (e.g., an AI/ML concierge) of a multi-client service system platform; parsing the natural language command using AI/ML parsing functionality to determine a desired outcome; generating programming code for execution to achieve the desired outcome; executing the programming code to generate content related to the desired outcome, wherein the programming code interacts with objects within a customer relationship management (CRM) database of a storage system; and displaying the content through the chat interface.

In some embodiments, the operations include in response to the AI/ML copilot receiving a chat-based command through the chat interface, generating a follow-up email based upon information within the objects in the CRM database.

In some embodiments, the operations include in response to the AI/ML copilot receiving a chat-based command through the chat interface, generating and including an image within a blog article.

In some embodiments, the operations include in response to the AI/ML copilot receiving a chat-based command through the chat interface, generating a custom report using information from the objects within the CRM database.

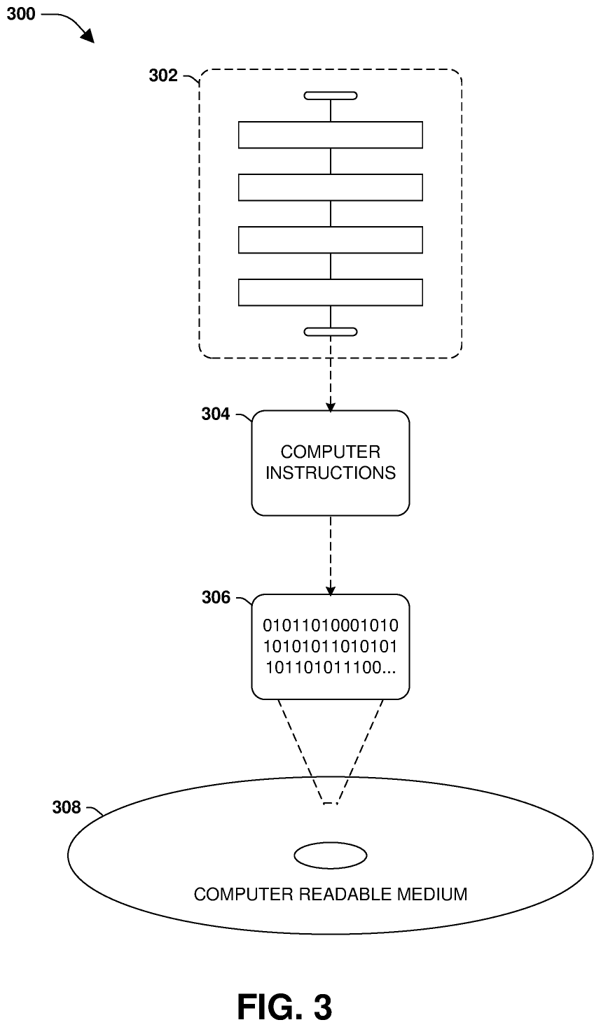

Still another embodiment involves a computer-readable medium comprising processor-executable instructions configured to implement one or more of the techniques presented herein. An example embodiment of a computer-readable medium or a computer-readable device is illustrated in FIG. 3, wherein the implementation 300 comprises a computer-readable medium 308, such as a CD-R, DVD-R, flash drive, a platter of a hard disk drive, etc., on which is encoded computer-readable data 306. This computer-readable data 306, such as binary data comprising at least one of a zero or a one, in turn comprises a set of computer instructions 304 configured to operate according to one or more of the principles set forth herein. In some embodiments, the processor-executable computer instructions 304 are configured to perform a method 302 such as method 200 of FIG. 2, for example. In some embodiments, the processor-executable instructions 304 are configured to implement a system. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 4 and the following discussion provide a brief, general description of a suitable computing environment to implement embodiments of one or more of the provisions set forth herein. The operating environment of FIG. 4 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 4 illustrates an example of a system 400 comprising a computing device 412 configured to implement one or more embodiments provided herein. In one configuration, computing device 412 includes at least one processing unit 416 and memory 418. Depending on the exact configuration and type of computing device, memory 418 may be volatile (such as RAM, for example), non-volatile (such as ROM, flash memory, etc., for example) or some combination of the two. This configuration is illustrated in FIG. 4 by dashed line 414.

In some embodiments, the computing device 412 utilizes an architecture corresponding to Front-end in NextJS/React. Back-end in Python. Database in MySQL.

In other embodiments, device 412 may include additional features and/or functionality. For example, device 412 may also include additional storage (e.g., removable and/or non-removable) including, but not limited to, magnetic storage, optical storage, and the like. Such additional storage is illustrated in FIG. 4 by storage 420. In one embodiment, computer readable instructions to implement one or more embodiments provided herein may be in storage 420. Storage 420 may also store other computer readable instructions to implement an operating system, an application program, and the like. Computer readable instructions may be loaded in memory 418 for execution by processing unit 416, for example.

The term “computer readable media” as used herein includes computer storage media. Computer storage media includes volatile and nonvolatile, removable and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 412. Computer storage media does not, however, include propagated signals. Rather, computer storage media excludes propagated signals. Any such computer storage media may be part of device 412.

Device 412 may also include communication connection(s) 426 that allows device 412 to communicate with other devices. Communication connection(s) 426 may include, but is not limited to, a modem, a Network Interface Card (NIC), an integrated network interface, a radio frequency transmitter/receiver, an infrared port, a USB connection, or other interfaces for connecting computing device 412 to other computing devices. Communication connection(s) 426 may include a wired connection or a wireless connection. Communication connection(s) 426 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 412 may include input device(s) 424 such as keyboard, mouse, pen, voice input device, touch input device, infrared cameras, video input devices, and/or any other input device. Output device(s) 422 such as one or more displays, speakers, printers, and/or any other output device may also be included in device 412. Input device(s) 424 and output device(s) 422 may be connected to device 412 via a wired connection, wireless connection, or any combination thereof. In one embodiment, an input device or an output device from another computing device may be used as input device(s) 424 or output device(s) 422 for computing device 412.

Components of computing device 412 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 412 may be interconnected by a network. For example, memory 418 may be comprised of multiple physical memory units located in different physical locations interconnected by a network.

Those skilled in the art will realize that storage devices utilized to store computer readable instructions may be distributed across a network. For example, a computing device 430 accessible via a network 428 may store computer readable instructions to implement one or more embodiments provided herein. Computing device 412 may access computing device 430 and download a part or all of the computer readable instructions for execution. Alternatively, computing device 412 may download pieces of the computer readable instructions, as needed, or some instructions may be executed at computing device 412 and some at computing device 430.

FIG. 5 illustrates an example environment including a multi-client or tenant service business platform 510 (e.g., a multi-client distributed system) or generally “platform” in accordance with the present disclosure. As shown, the environment 500 includes a platform 510 which may be also referred to as a multi-tenant distributed system, a framework system, a multi-client distributed system, or a multi-function business platform that may serve the needs of multiple users who in turn use the system to provide services, support, and the like for their customers. The platform 510 communicates with various systems, devices, and data sources according to example embodiments of the disclosure.

The platform 510 communicates and sends/receives data over a communication network 560 (e.g., Internet, public network, private network, etc.). In particular, the platform 510 leverages network 560 to send and receive data with one or more user devices 570, one or more client devices 572, one or more third party services 574, one or more integrator devices 576, and external information sources and databases 580.

The platform 510 includes a Customer Relationship Management (CRM) System 502, a Directed Content System 504, an Artificial Intelligence/Machine Learning (AI/ML) System 506, a Content Management System (CMS) 508, a Multi-Client Ticketing System 1600, a Customization System 520, a customizable Events System 522, a Payments System 524, a Reporting System 526, a Conversational Intelligence System 528, a Custom Workflow System 562, 564, an Entity (or Object) Resolution System 566, an Infrastructure and Services System 530, a Storage System 550, and/or other systems in accordance with an aspect of the present disclosure.

Additionally, the platform 510 includes an AI/ML copilot system 101 and a chat interface 100 (e.g., an AI/ML content assistance system), which operates seamlessly with the platform 510. The AI/ML copilot system 101 is configured to send and receive data to any or all of the individual components shown in FIG. 5 to enable the use cases discussed herein. For example, the AI/ML copilot system 101 may generate content to display to a user using information extracted from the CRM System 502, the Directed Content System 504, the AI/ML System 506, the CMS 508, the Multi-Client Ticketing System 1600, the Customization System 520, the customizable Events System 522, the Payments System 524, the Reporting System 526, a Conversational Intelligence System 528, the Custom Workflow System 562 and 564, the Entity (or Object) Resolution System 566, the Infrastructure and Services System 530, and/or the Storage System 550.

Based upon natural language commands received through the chat interface 100, the AI/ML copilot system 101 may execute functionality provided by the CRM System 502, the Directed Content System 504, the AI/ML System 506 (e.g., utilize various models to generate outputs, predictions, and/or perform certain actions), the CMS 508, the Multi-Client Ticketing System 1600 (e.g., generate a new ticket, process an existing ticket, etc.), the Customization System 520, the customizable Events System 522 (e.g., execute or trigger an event), the Payments System 524 (e.g., perform a payment, review payments, generate an invoice, track an invoice, etc.), the Reporting System 526 (e.g., generate a report), a Conversational Intelligence System 528 (e.g., extract content related to conversations such as to create a transcript), the Custom Workflow System 562 and 564 (e.g., create or trigger custom workflows), the Entity (or Object) Resolution System 566 (e.g., create, modify or delete objects), the Infrastructure and Services System 530, and/or the Storage System 550.

The AI/ML copilot system 101 is shown in FIG. 5 as separate from the AI/ML System 506. However, in an embodiment, the AI/ML copilot 101 is combined with the AI/ML System 506. In another embodiment, the AI/ML copilot 101 leverages some or all of the AI/ML System 506 and sends/receives data therewith to allow the platform 510 to perform the functions described herein.

These systems may function and/or be used similarly to the same or similar systems described in the disclosure. For example, the AI/ML system 506 is used with core objects and are also applied similarly to the custom objects. The platform 510 may synchronize some arbitrary custom objects outside the platform 510 to objects in the platform 510. In summary, in examples, the platform 510 may act as an arbitrary platform that may act on arbitrary custom objects using various systems 502-508, 1600, 520, 522-528, 562, 566 and the services 530 (e.g., used with arbitrary actions and synced to arbitrary systems of the platform) thereby benefiting from these various capabilities. The external information sources 580 may include company information or data on customers, products, sales, third party data, resource description framework (RDF) site summary (RSS) feeds or really simple syndication (RSS) feeds, telemetrics (e.g., from email, websites, app usage), and the like with respect to custom objects. The platform 510 may also communicate with third party service(s) 574 (e.g., third party applications, websites, databases, etc.) via network 560. The platform 510 may also communicate with one or more integrator device(s) or apps 576, also referred to as developer apps. Developer apps 576 may refer to user devices used by third-party integrators or developers who may create, define and deploy a series of custom objects, events, workflows, website themes and other services that may be integrated with other objects in the platform 510. The platform 510 is configured to seamlessly connect and integrate objects and services that are deployed through an integrator or developer which then may be offered to users (e.g., clients) via the platform 510. For example, the platform 510 may include internal and external APIs (as described in the disclosure) that a developer or integrator may use to define custom objects and integrate those custom objects into the CRM system 502. The integrator users may define a series of custom objects and then define object definitions. When a client device installs that integration, the platform 510 may enable the user to then start creating and using instances of custom objects defined by the integrator users.

The AI/ML copilot 101 (e.g., an AI/ML concierge) includes a chat interface 100 which allows users to input natural language commands that are processed using the power of AI/ML copilot 101. The AI/ML copilot 101 can generate a wide variety of outputs based upon the natural language commands, such as programmatically generating reports, a blog on a particular topic, a presentation slide, a spreadsheet, images, software code, emails, contacts, etc. With the AI/ML copilot 101, a user can complete a task using a declarative approach where the user inputs a natural language statement as a command/query that describes an outcome (e.g., “generate a report on a company ABC”), but does not include the actual functional steps or code to achieve the outcome. Instead, the AI/ML copilot 101 takes the natural language statement as input, and generates and performs the functional steps or code that produces the outcome described by the natural language statement.

In some embodiments, the AI/ML copilot 101 is linked to other various modules the multi-client service system platform 510, data sources (e.g., a website, a customer relations management database, an image repository, etc.) from sources 580 and/or the Storage System 550, applications (e.g., a spreadsheet application, a presentation application, a word processing document, a social network application, an email or messaging application, etc.), and services (e.g., an email service) in order to enhance the capabilities of the chat interface. In some embodiments, the AI/ML copilot 101 links to the CRM System 502 in order to leverage information within the CRM System 502 and populate new information within the CRM System 502 (e.g., create tasks, create contacts, view marketing information, perform various analysis on sales data, create reports, etc.) based upon natural language commands input through the chat interface. In some embodiments, the AI/ML copilot 101 and/or the chat interface 100 may be integrated into and/or is a part of the multi-client service system platform 510.

The AI/ML copilot 101 may implement various application programming interfaces (APIs) in order to interface with the modules (e.g., an API used to access the CRM System 502, a REST API to access a service accessible over a network, etc.). The AI/ML copilot 101 may link to various applications, services, and content such as a spreadsheet application, a word processing application, a presentation application, a blogging service, a social network service, websites, databases, an image repository, social network profiles and posts, and/or other content in order to process natural language commands input through the chat interface 100, which was described in different use cases in FIGS. 1A-1C.

In an embodiment, the AI/ML copilot 101 links to an artificial intelligence system of an integrator app 576 that can create images and art from descriptions submitted through the chat interface 100 in natural language. In another embodiment, the AI/ML copilot 101 links to another integrator app 576 such as a keyword research service or tool that provides topics and content (e.g., ideas, concepts, topics, paragraphs of text, sentences of text, etc.) related to natural language commands input through a chat interface 100 of the AI/ML copilot 101.

When a user inputs a natural language command through the chat interface 100 (e.g., “generate a report on a company ABC”), the AI/ML copilot 101 automatically selects certain modules, corresponding to the platforms, data sources, applications, and/or services, to utilize for processing the natural language command. The natural language command may describe a desired outcome such as the report about the company ABC, which may be used by the AI/ML copilot 101 to select one or more of the modules to utilize for generating the desired outcome. The desired outcome, derived from the natural language command, may be used to select an order with which to access/invoke the modules, what inputs to input into each module (e.g., an output from one module may be used as an input to another module), and what outputs are expected from each module. For example, the CRM System 502 and Storage System 550, a website of the company ABC, a business information repository, a social network service hosting a social network profile of the company ABC, and/or other modules or content may be selected in order to obtain information that the AI/ML copilot 101 will use to generate the report. In this way, natural language commands input through the chat interface are used by the AI/ML copilot 101 to select, order, and/or invoke certain modules in order to generate content using artificial intelligence, machine learning, and/or various types of models, which can be used by business growth professionals such as customer service agents, executives, a marketing team, a sales team, and/or a wide variety of other types of users. The order may be programmatically determined based upon what inputs and outputs are expected by the modules (e.g., if a workflow is to be triggered using information about a contract being negotiated, then information from a contract object within a CRM database may be first extracted, and is then input into the workflow automation module 532).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system comprising:
a storage system including a customer relationship management (CRM) database; and
a multi-client service system platform that includes an artificial intelligence and machine learning (AI/ML) copilot configured to host a chat interface, wherein the AI/ML copilot performs operations including:
receiving a natural language command through the chat interface;
parsing the natural language command using AI/ML parsing functionality to determine a desired outcome;
generating programming code for execution to achieve the desired outcome;
executing the programming code to generate content related to the desired outcome, wherein the programming code interacts with objects within the CRM database; and
displaying the content through the chat interface.

2. The system of claim 1, wherein the AI/ML copilot displays a suggestion interface populated with suggested natural language commands.

3. The system of claim 1, wherein the AI/ML copilot transitions a user from the chat interface to a CRM application.

4. The system of claim 1, wherein the AI/ML copilot transitions a user from the chat interface to a spreadsheet application displaying a spreadsheet generated and populated by the AI/ML copilot using information within the content displayed through the chat interface.

5. The system of claim 1, wherein the AI/ML copilot transitions a user from the chat interface to a presentation application displaying a presentation generated and populated by the AI/ML copilot using information within the content displayed through the chat interface.

6. The system of claim 1, wherein the AI/ML copilot transitions a user from the chat interface to a blog service displaying a blog generated by the AI/ML copilot using information within the content displayed through the chat interface.

7. A method, comprising:
receiving a natural language command through a chat interface hosted by an artificial intelligence and machine learning (AI/ML) copilot of a multi-client service system platform;
parsing the natural language command using AI/ML parsing functionality to determine a desired outcome;
generating programming code for execution to achieve the desired outcome;
executing the programming code to generate content related to the desired outcome, wherein the programming code interacts with objects within a customer relationship management (CRM) database of a storage system; and
displaying the content through the chat interface.

8. The method of claim 7, comprising:
providing, through the chat interface, a toggle option to toggle between manual creation and AI generated content by the AI/ML copilot for creating new content.

9. The method of claim 7, comprising:
in response to the AI/ML copilot receiving a chat-based command through the chat interface, executing a database command to modify the CRM database.

10. The method of claim 7, comprising:
in response to the AI/ML copilot receiving a chat-based command through the chat interface, creating a new contact object within the CRM database.

11. The method of claim 7, comprising:
in response to the AI/ML copilot receiving a chat-based command through the chat interface, creating and sending an email.

12. The method of claim 7, comprising:
in response to the AI/ML copilot receiving a chat-based command through the chat interface, obtaining and displaying a report generated from the objects within the CRM database.

13. The method of claim 7, comprising:
in response to the AI/ML copilot receiving a chat-based command through the chat interface, deduplicating the objects within the CRM database.

14. The method of claim 7, comprising:
in response to the AI/ML copilot receiving a chat-based command through the chat interface, automatically capturing and transcribing a recorded conversation to create a transcription.

15. The method of claim 7, comprising:
in response to the AI/ML copilot receiving a chat-based command through the chat interface, logging and segmenting email contact information.

16. The method of claim 7, comprising:
in response to the AI/ML copilot receiving a chat-based command through the chat interface, importing contact and company information from a spreadsheet by mapping each cell of the spreadsheet to a CRM property of the objects within the CRM database.

17. A non-transitory computer-readable medium storing instructions that when executed facilitate performance of operations comprising:
receiving a natural language command through a chat interface hosted by an artificial intelligence and machine learning (AI/ML) copilot of a multi-client service system platform;
parsing the natural language command using AI/ML parsing functionality to determine a desired outcome;
generating programming code for execution to achieve the desired outcome;
executing the programming code to generate content related to the desired outcome, wherein the programming code interacts with objects within a customer relationship management (CRM) database of a storage system; and
displaying the content through the chat interface.

18. The non-transitory computer-readable medium of claim 17, wherein the operations further comprise:
in response to the AI/ML copilot receiving a chat-based command through the chat interface, generating a follow-up email based upon information within the objects in the CRM database.

19. The non-transitory computer-readable medium of claim 17, wherein the operations further comprise:
in response to the AI/ML copilot receiving a chat-based command through the chat interface, generating and including an image within a blog article.

20. The non-transitory computer-readable medium of claim 17, wherein the operations further comprise:
in response to the AI/ML copilot receiving a chat-based command through the chat interface, generating a custom report using information from the objects within the CRM database.
